(19) United States
(12) Patent Application Publication
(10) Pub. No.: US 2025/0321552 A1
(43) Pub. Date: Oct. 16, 2025

(54) MODULAR AND FLEXIBLE BACNET INTEGRATION STACK USING SOCKET-BASED APPLICATION PROGRAMMING INTERFACE

(71) Applicant: Tyco Fire & Security GmbH, Neuhausen am Rheinfall (CH)

(72) Inventors: Louis Nunzio Loizides, Safety Harbor, FL (US); Eric G. Lang, Milwaukee, WI (US); Christopher Charles Davidoff, Longmont, CO (US); Shivam Rajvanshi, New Delhi (IN); Redick Simon, Tamil Nadu (IN)

(21) Appl. No.: 18/632,026

(22) Filed: Apr. 10, 2024

(51) Int. Cl. G05B 15/02; G06F 9/48; G06F 9/50

(52) U.S. Cl. CPC G05B 15/02; G06F 9/485; G06F 9/505; G05B 2219/2614

(57) ABSTRACT

Systems and methods for implementing building automation and control network (BACnet) stacks having socket-based application programming interfaces (APIs) are disclosed. A system can implement a BACnet component. The BACnet component can provide socket-based API configured to receive commands for accessing at least one BACnet system. The BACnet component can receive, via the socket-based API, a first command to be communicated via a BACnet protocol. The BACnet component can convert the first command to a BACnet instruction. The BACnet component can transmit the BACnet instruction using the BACnet protocol to the BACnet system.

### BACKGROUND

The present disclosure relates generally to building management and control systems for building equipment, and more particularly to systems and methods for implementing a modular and flexible building automation and control network (BACnet) stack using socket-based application programming interfaces (APIs).

Building devices may communicate with one or another over various types of networks, including BACnet networks. However, each device must implement a custom, specialized implementation of BACnet to properly interface its network hardware with other devices via BACnet. It is challenging to efficiently implement and deploy BACnet communication interfaces on different types of building devices.

### SUMMARY

At least one aspect of the present disclosure is directed to a system. The system can include one or more processors coupled to non-transitory memory. The system can implement a BACnet component. The system can provide a socket-based application programming interface (API) configured to receive commands for accessing at least one BACnet system. The system can receive, via the socket-based API, a first command to perform a control operation or communicate via a BACnet protocol. The system can store the first command in a load-balancing queue data structure. The system can convert the first command to a corresponding BACnet instruction. The system can transmit the BACnet instruction using the BACnet protocol.

In some implementations, the first command is received according to a first network protocol different from the BACnet protocol. In some implementations, the first command comprises a command to retrieve at least one value from the specified BACnet system or a command to control the specified BACnet system. In some implementations, the first command comprises the command to control the specified BACnet system. In some implementations, transmitting the BACnet instruction to the BACnet system causes the BACnet system to modify an internal value maintained by the BACnet system.

In some implementations, the first command comprises the command to retrieve the at least one value from a specified BACnet system. In some implementations, the system can convert the first command to the corresponding BACnet instruction to retrieve the at least one value from the specified BACnet system. In some implementations, the system can retrieve, using the corresponding BACnet instruction, the at least one value from the specified BACnet system. In some implementations, the first command identifies a time period for retrieving values from the specified BACnet system. In some implementations, the system can retrieve the at least one value from the specified BACnet system prior to expiration of the time period. In some implementations, the system can receive, via the socket-based API, a second command to identify BACnet systems on a network.

In some implementations, the system can convert the second command to a second corresponding BACnet instruction. In some implementations, the system can identify, via the BACnet protocol and using the second corresponding BACnet instruction, one or more BACnet systems on the network. In some implementations, the first command is received from a computing system or a component. In some implementations, the system can receive a response to the BACnet instruction. In some implementations, the system can generate data based on to the response according to a format compatible with the computing system or the component. In some implementations, the system can transmit the data to the computing system or the component. In some implementations, the system can store the first command in a load-balancing queue data structure. In some implementations, the BACnet component is further configured to receive a response to the BACnet instruction from the BACnet system. In some implementations, the BACnet component is further configured to store at least a portion of the response in a task queue data structure.

At least one other aspect of the present disclosure is directed to a method. The method may be performed, for example, by one or more processors coupled to memory. The method includes implementing a BACnet component configured to perform operations. Various steps of the method may be performed using the BACnet component. The method includes providing a socket-based application programming interface (API) configured to receive commands for accessing at least one BACnet system. The method includes receiving, via the socket-based API, a first command to perform a control operation or communicate via a BACnet protocol. The method includes storing the first command in a load-balancing queue data structure. The method includes converting the first command to a corresponding BACnet instruction. The method includes transmitting the BACnet instruction using the BACnet protocol.

In some implementations, the first command is received according to a first network protocol different from the BACnet protocol. In some implementations, the first command comprises a command to retrieve at least one value from the specified BACnet system or a command to control the specified BACnet system. In some implementations, the method includes the first command comprises the command to control the specified BACnet system. In some implementations, transmitting the BACnet instruction to the BACnet system causes the BACnet system to modify an internal value maintained by the BACnet system. In some implementations, the first command comprises the command to retrieve the at least one value from a specified BACnet system. In some implementations, the method includes converting the first command to the corresponding BACnet instruction to retrieve the at least one value from the specified BACnet system. In some implementations, the method includes retrieving, using the corresponding BACnet instruction, the at least one value from the specified BACnet system.

In some implementations, the first command identifies a time period for retrieving values from the specified BACnet system. In some implementations, the method includes retrieving the at least one value from the specified BACnet system prior to expiration of the time period. In some implementations, the method includes receiving, via the socket-based API, a second command to identify BACnet systems on a network. In some implementations, the method includes converting the second command to a second corresponding BACnet instruction. In some implementations, the method includes identifying, via the BACnet protocol and using the second corresponding BACnet instruction, one or more BACnet systems on the network.

In some implementations, the first command is received from a computing system or a component. In some implementations, the method includes receiving a response to the BACnet instruction. In some implementations, the method includes generating data based on to the response according to a format compatible with the computing system or the component. In some implementations, the method includes transmitting the data to the computing system or the component. In some implementations, the method includes storing the first command in a load-balancing queue data structure. In some implementations, the method includes receiving a response to the BACnet instruction from the BACnet system. In some implementations, the method includes storing at least a portion of the response in a task queue data structure.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined, and it will be readily appreciated that features described in the context of one aspect of the invention can be combined with other aspects. Aspects can be implemented in any convenient form. For example, aspects can be implemented by appropriate computer programs, which may be carried on appropriate carrier media (computer readable media), which may be tangible carrier media (e.g., disks) or intangible carrier media (e.g., communications signals). Aspects may also be implemented using suitable apparatuses, which may take the form of programmable computers running computer programs arranged to implement the aspect. As used in the specification and in the claims, the singular form of “a,” “an,” and “the” include plural referents unless the context clearly dictates otherwise.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system that may be used in conjunction with the building of FIG. 1, according to some embodiments.

FIG. 3 is a block diagram of an airside system that may be used in conjunction with the building of FIG. 1, according to some embodiments.

FIG. 4 is a block diagram of a building management system (BMS) that may be used to monitor and/or control the building of FIG. 1, according to some embodiments.

FIG. 5 is a block diagram of a computing platform that may be utilized to implement modular and flexible BACnet integration components using socket-based APIs, according to some embodiments.

FIG. 6 is a block diagram illustrating an example data flow diagram of an example BACnet integration component, according to some embodiments.

FIG. 7 is a flowchart of an example process for implementing an example BACnet integration component, according to some embodiments.

### DETAILED DESCRIPTION

### Overview

Referring generally to the FIGURES, systems and methods for implementing modular and flexible BACnet integration stack using socket-based APIs are disclosed, according to various exemplary embodiments. Conventional approaches for implementing BACnet communication processes require device-specific implementations for BACnet protocols. When such protocols are updated or otherwise modified, these changes must be propagated to several, device-specific implementations, often requiring device-specific changes that result in inconsistencies between device implementations for BACnet communications. These inconsistencies increase the instance of computer-based implementation errors, and require device-specific debugging, bug-fixing, or other modifications to be performed that cause inconsistencies between BACnet implementations. Additionally, this lack of uniformity between implementations can result in significant computational bottlenecks when different implementations attempt to communicate with one another (e.g., due to a lack of multi-device optimizations).

The systems and methods of this technical solution address these and other issues by providing a cross-platform BACnet component implemented using socket-based application programming interfaces combined with load balancing distributed queue(s). The load balancing queue allows for the multithreaded code regardless of device implementation, significantly improving memory safety, computational efficiency, and cross-device compatibility. The BACnet stacks described herein are language agnostic, and may be implemented to communicate using any type of BACnet-compatible device. The techniques described herein further enable definition of customized BACnet objects, which may be implemented according to one or more templates. Such templates enable the definition of a BACnet object using any suitable programming or scripting language. These and other advantages and improvements provided by the systems and methods of the present disclosure are described in greater detail below.

Referring generally to the FIGURES, systems and methods for providing modular and flexible BACnet integration stacks using socket-based APIs are disclosed, according to various exemplary embodiments. The BACnet components described herein can be implemented to communicate with any type of BACnet-enabled device. The BACnet components described herein can be implemented at the edge on one or more building systems, by a server, or by a cloud computing system. As utilized herein, the term “server” can include any type of computing device (e.g., application server, Internet/web server(s) or cloud-based server(s), a computing device such as an edge computing device having software/firmware configured to cause the device to have server capabilities/functionality, etc.), and is not restricted to a particular architecture.

Building with Building Systems

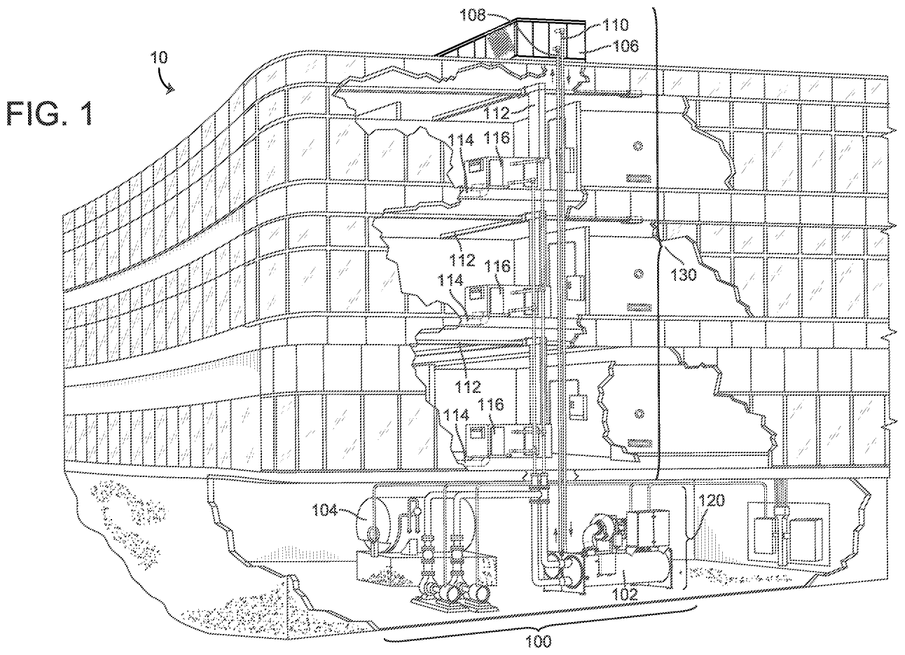

Referring now to FIGS. 1-4, an exemplary building management system (BMS) and heating, ventilation, and air-conditioning (HVAC) system in which the systems and methods of the present disclosure can be implemented are shown, according to some embodiments. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire safety system, any other system that is capable of managing building functions or devices, or any combination thereof.

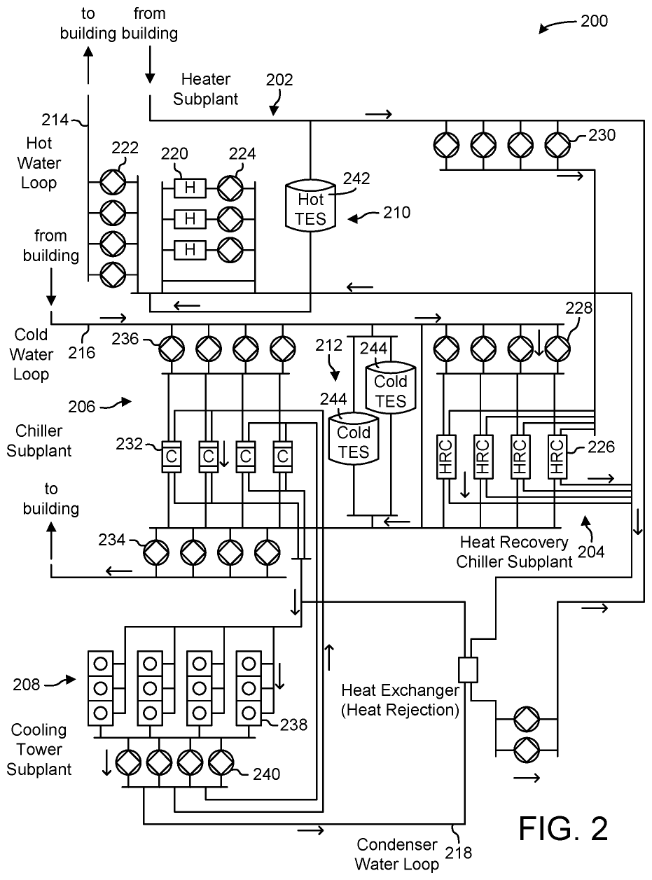

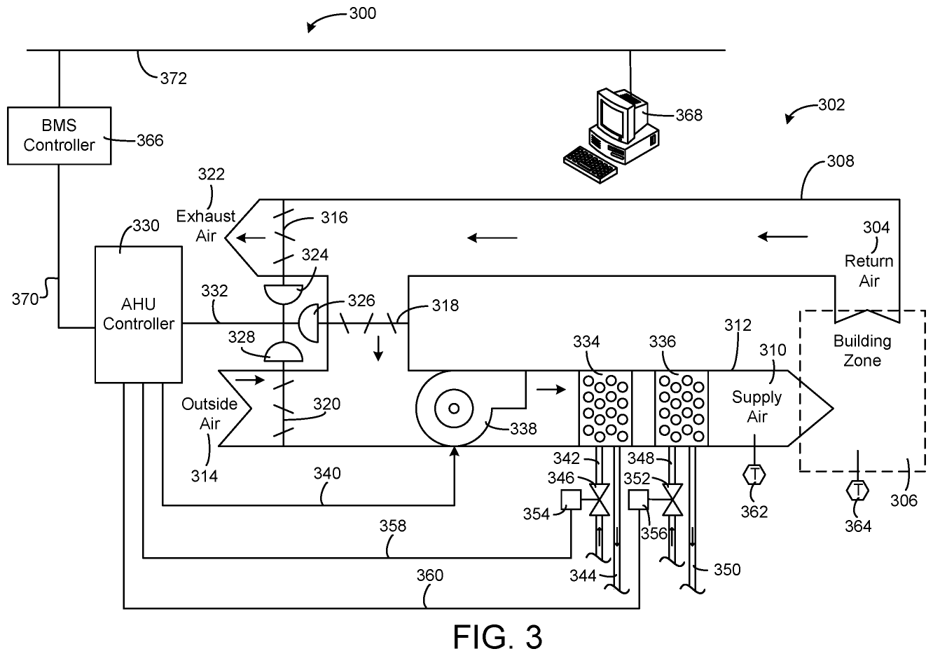

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone. Any of the devices or components of the HVAC system 100 may communicate via one or more BACnet interfaces or using one or more BACnet protocols.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to some embodiments. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

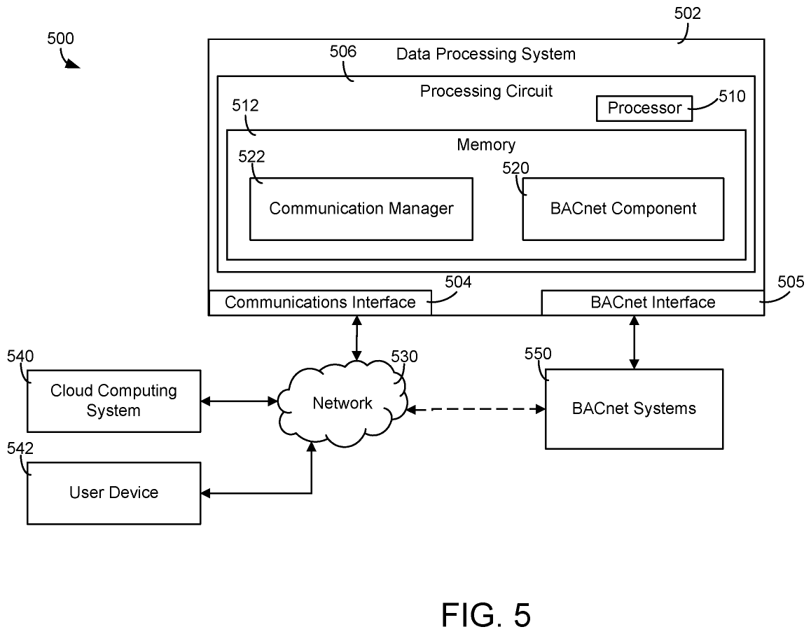

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328. AHU controller 330 may also implement one or more test signals received from another computing system, such as the correlation system 502 described in connection with FIG. 5.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building automation system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

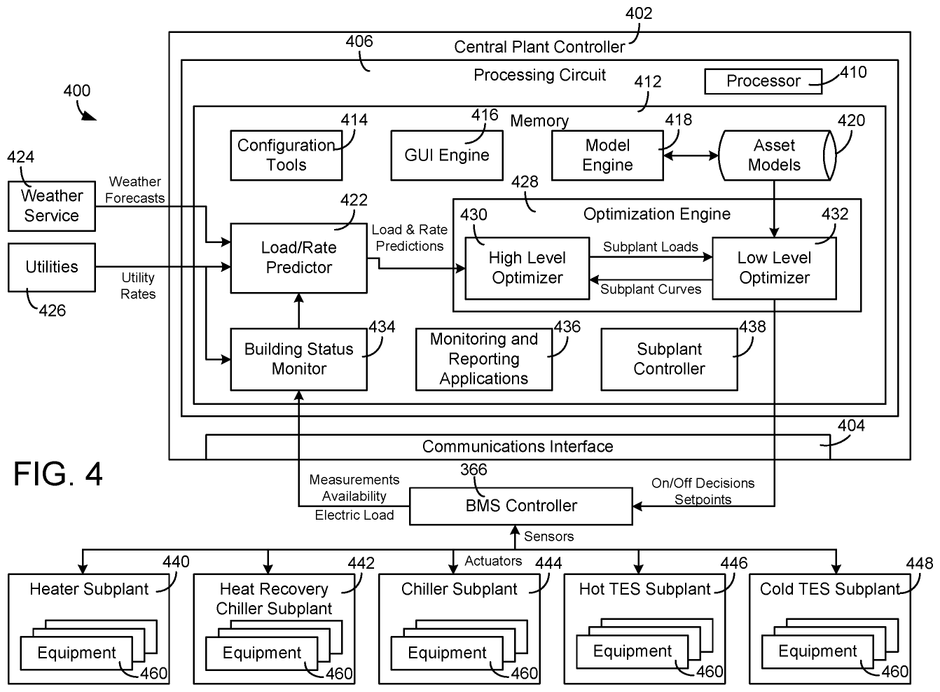

Referring now to FIG. 4, a block diagram of a building automation system (BMS) 400 is shown, according to some embodiments. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., cybersecurity, efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super-system. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shutdown systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Modular And Flexible BACnet Integration Stack

Referring now to FIG. 5, illustrated is a block diagram of a system 500 for implementing modular and flexible BACnet integration components, according to some embodiments. The system 500 is shown to include a data processing system 502, a network 530, a cloud computing system 540, a user device 542, and one or more BACnet systems 550. While shown in the system 500 as singular components, each of system 502, the cloud computing system 540, the user device 542 and the building systems 550 may be implemented across multiple devices (e.g., via distributed computing architectures, multiple discrete devices, etc.).

The data processing system 502, the cloud computing system 540, the user device 542, and the BACnet systems 550 may each include computing devices or systems that include a processor and memory for storing and executing instructions. Said memory may include one or more devices (e.g., RAM, ROM, Flash memory, hard disk storage, etc.) for storing data or computer code for completing or facilitating the various processes, layers, and modules described herein. The memory may be or include volatile memory or non-volatile memory and may include database components, object code components, script components, or any other type of information structure for supporting the various activities and information structures described herein.

The data processing system 502 is shown to include a processing circuit 506, which includes a processor 510 and a memory 512. It will be appreciated that these components can be implemented using a variety of different types and quantities of processors and memory. For example, processor 510 can be a general-purpose processor, an ASIC, one or more FPGAs, a group of processing components, or other suitable electronic processing components. Processor 510 can be communicatively coupled to memory 512. While processing circuit 506 is shown as including one processor 510 and one memory 512, it should be understood that, as discussed herein, a processing circuit or memory may be implemented using multiple processors or memories which may be located within the same physical device or distributed across multiple discrete physical devices or systems in the same or different physical locations in various embodiments. All such implementations are contemplated within the scope of the present disclosure.

The data processing system 502 is shown to include a communications interface 504. Communications interface 504 can include wired or wireless communications interfaces (e.g., jacks, antennas, transmitters, receivers, transceivers, wire terminals, etc.) for conducting data communications with the cloud computing system 540, the user device(s) 542, or other external systems or devices. Communications conducted via communications interface 504 can be direct (e.g., local wired or wireless communications) or via a communications network 530 (e.g., a WAN, the Internet, a cellular network, etc.).

Communications interface 504 can facilitate communications between data processing system 502 and external applications (e.g., remote systems and applications) for allowing user control, monitoring, and adjustment to data processing system 502 and/or the devices that communicate with data processing system 502. Communications interface 504 can also facilitate communications between data processing system 502 and client devices (e.g., the user device(s) 542, computer workstations, laptop computers, tablets, mobile devices, etc.). The data processing system 502 can be configured to communicate with external systems and devices using any of a variety of communications protocols (e.g., HTTP(S), WebSocket, CoAP, MQTT, etc.), industrial control protocols (e.g., MTConnect, OPC, OPC-UA, etc.), process automation protocols (e.g., HART, Profibus, etc.), home automation protocols, or any of a variety of other protocols. Advantageously, data processing system 502 can receive, ingest, and process data from any type of system or device regardless of the communications protocol used by the system or device.

The data processing system 502 is shown as including a BACnet interface 505. The BACnet interface 505 can include any type of communications interface that is capable of transmitting messages, signals, or data via a BACnet protocol. In some implementations, the BACnet interface 505 may be a network interface such as (such as Ethernet or MS/TP), which may be in communication with various BACnet systems 550 of a building, as shown. In some implementations, the BACnet interface 505 may include one or more software components that implement BACnet communication protocols via a network layer (e.g., IPv4 or IPv6) and/or application layer of a network stack. In some implementations, the BACnet interface 505 may be similar to, and may include any of the structure of functionality of, the communications interface 504. The BACnet interface 505 may be accessed or otherwise utilized by the BACnet component 520, for example, to communicate with (e.g., provide BACnet instructions to or receive BACnet messages from) one or more BACnet systems 550.

The system 500 is shown as including one or more BACnet systems 550. The BACnet systems 550 can include any type of computing device or building device that includes BACnet functionality. For example, the BACnet systems 550 may include BACnet clients or BACnet servers, and communicate via one or more networks (e.g., the network 540, one or more specialized BACnet networks, etc.) of one or more buildings. can be any type of system that may be disposed within or for a building, any may include any of the devices, systems, or computing devices described in connection with FIG. 1, 2, 3, or 4. The building systems 550 can any type of device that can communicate using a BACnet protocol, and may include one or more control devices and and/or building devices of a building.

Examples of control devices can include any type of device or system that is responsible for controlling physical parameter(s) of the building, including thermostats, AHUs, waterside systems, locking systems, automatic or controlled door mechanisms, or other types of devices that can control aspects of a building. Such devices can include sensors that provide data relating to the particular control device, such as return air temperature, return air pressure, return water temperature, or return water pressure, locking mechanism state, etc. Such sensors, or data provided thereby, may be represented as one or more BACnet objects maintained by said device(s).

The BACnet systems 550 may further including any type of building device, which may include any type of device that can monitor physical parameter of the building (e.g., aside from control operations). Examples of such building devices 554 include sensors (e.g., air temperature, air pressure, water temperature, water pressure, etc.) within VAVs, or other types of devices within a building that are coupled to an AHU, or to a waterside system, security cameras, proximity/motion sensors, building state sensors, among other types of building devices. Building sensors include air or water temperature or pressure sensors disposed in various spaces of the building, for example. The BACnet systems 550 of the system 500 can provide or otherwise maintain various sensor data as BACnet data. The BACnet systems 550 can receive control instructions or transmit requested data (e.g., sensor data) via a BACnet protocol. The BACnet systems 550 may include one or more BACnet gateways that coordinate messages between BACnet-enabled devices of a building. Each BACnet system or device may be identified/discoverable via a corresponding BACnet identifier (e.g., via a “who is” instruction), in some implementations. As shown, the BACnet systems 550 may communicate with the data processing system 502 via the BACnet interface 505. In some implementations, the BACnet systems 550 may communicate with the data processing system 502 via the network 530 (e.g., using an IP or application layer BACnet communications, etc.).

The data processing system 502 can communicate with a cloud computing system 540 via a network 530. The network 530 can communicatively couple the devices and systems of the system 100. In some embodiments, the network 530 is at least one of or a combination of a Wi-Fi network, a wired Ethernet network, a ZigBee network, a Bluetooth network, BACnet network, or any other wireless network. The network 530 may be a local area network or a wide area network (e.g., the Internet, a building WAN, etc.) and may use a variety of communications protocols (e.g., BACnet, IP, LON, etc.). The network 530 may include routers, modems, servers, cell towers, satellites, and/or network switches. The network 530 may be a combination of wired and wireless networks. Although only one cloud computing system 540 is shown in the system 100 for visual clarity and simplicity, it should be understood that any number of building systems 112 (corresponding to any number of buildings) can be included in the system 500 and communicate with the data processing system 502 as described herein.

The network 530 can be configured to facilitate communication and routing of messages between the data processing system 502, one or more user devices 542, and the cloud computing system 540, or any other system. The data processing system 502 can include any of the components described herein, and can implement any of the processing functionality of the devices described herein. In an embodiment, the data processing system 502 can host a web-based service or website, via which the user device 542 can access one or more user interfaces to coordinate various functionality described herein. In some embodiments, the data processing system 502 can facilitate communications between various computing systems described herein via the network 530. Various API endpoints of the BACnet component 522 can be accessed via corresponding network addresses (e.g., uniform resource identifiers (URIs), uniform resource locators (URLs), other types of network addresses, etc.), to access the functionality of the BACnet component 522.

The user device 542 may be a laptop computer, a desktop computer, a smartphone, a tablet, and/or any other device with an input interface (e.g., touch screen, mouse, keyboard, etc.) and an output interface (e.g., a speaker, a display, etc.). The user device 542 can receive input via the input interface, and provide output via the output interface. For example, the user device 542 can receive user input (e.g., interactions such as mouse clicks, keyboard input, tap or touch gestures, etc.), which may correspond to interactions. In some implementations, the user device 542 may be used to communicate one or more API commands (e.g., via APIs provided or otherwise exposed by the BACnet component 520) to the data processing system 502 via the network 530.

The user device 542 can be in communication with the data processing system 502 via the network 530. In some implementations, the user device 542 can access one or more web-based user interfaces or native application interfaces provided by the data processing system 102 (e.g., by accessing a corresponding URL or URI, etc.). In response to corresponding interactions with the user interfaces, the user device 542 can transmit requests, which may include commands via the APIs of the BACnet component 520, to the data processing system 502 to perform one or more operations, including various operations to identify, request, subscribe to, control, or otherwise access the functionality of one or more BACnet systems 550. The user device 542 may provide any of the commands described herein in connection with the BACnet component 520.

In some implementations, the data processing system 502 and/or the user device 542 can communicate with the cloud computing system 540 via the network 530. The cloud computing system 540 can include various processors, memory, and/or computing devices. The cloud computing system 540 can include a distributed computing environment that executes applications to manage various operations of one or more buildings. For example, the cloud computing system 540 may be in communication with one or more gateways (which may include the data processing system 502) to coordinate updates, retrieve building data, or otherwise manage any processes of the building.

The cloud computing system 540 can, in some implementations, receive various messages or commands from the user device 542 to access functionality of the data processing system 502. For example, the cloud computing system 540 can receive messages or commands from the user device 542 and provide said messages and/or commands to corresponding API endpoints of the BACnet component 520 of the data processing system 502. Responses or messages generated via the BACnet component 520, as described in further detail herein, may be provided to the cloud computing system 540. Any data provided to the cloud computing system 540 can be stored and/or provided to one or more user devices 542.

For example, user devices 542 may access a web-based platform (e.g., a webserver) provided by the cloud computing system 540, which may be accessible via the network 530. Using the web-based platform, the user device 542 can transmit requests to and/or receive data from API endpoints of the BACnet component 520 the data processing system 502. Any information provided to or generated by the BACnet component 520, as described in further detail herein, can be provided to the cloud computing system 540, in some implementations.

The data processing system 502 is shown as including the memory 512. Memory 512 can include one or more devices (e.g., memory units, memory devices, storage devices, etc.) for storing data and/or computer code for completing and/or facilitating the various processes described in the present disclosure. Memory 512 can include random access memory (RAM), read-only memory (ROM), hard drive storage, temporary storage, non-volatile memory, flash memory, optical memory, or any other suitable memory for storing software objects and/or computer instructions. Memory 512 can include database components, object code components, script components, or any other type of information structure for supporting the various techniques and information structures described herein. Memory 512 can be communicably connected to processor 510 via processing circuit 506 and can include computer code for executing (e.g., by processor 510) one or more processes described herein.

Memory 512 is shown to include a communication manager 522, which can coordinate or otherwise manage communications of the data processing system 502 or the components thereof with the network 530. The communication manager 522 can transmit or receive messages to or from any type of network-enabled device (e.g., the cloud computing system 540, the user device 542, etc.) to perform any of the functionalities described herein. For example, the communication manager 522 can generate or receive internet protocol (IP) packets relating to communications with the cloud computing system 540 and/or one or more user devices 542. The communication manager 540 can receive, in some implementations, packets that include API commands for the BACnet component 520. In such implementations, the communication manager 522 can parse received data to extract the API commands provide said commands to the BACnet component 520 to perform various operations described herein. Likewise, the communication manager 522 can receive data via one or more APIs of the BACnet component 520, generate and/or format the data according to a network protocol of the network 530, and transmit the converted data to a destination device (e.g., the cloud computing system 540, the user device 542, etc.) using the communications interface 504.

Memory 512 is shown to include a BACnet component 520, which can communicate with the BACnet systems 550 of one or more buildings. In one example, the data processing system 502 may be or include one or more gateways of a building, which can act as an intermediary between one or more user devices 542, the cloud computing systems 540, and/or one or more other servers or computing devices, and the BACnet systems 550. The BACnet component 520 can implement a platform and language agnostic BACnet stack, and can provide one or more APIs to translate platform-agnostic commands to BACnet instructions that are transmitted to one or more corresponding BACnet systems 550.

The data processing system 502 can implement the BACnet component by executing the BACnet component, for example, in response to corresponding input from the cloud computing system 540, the user device user 542, another external computing system or server in communication with the data processing system 502, or via input (e.g., manual input, etc.) to an input device of the data processing system 502. In some implementations, the data processing system 502 can receive the BACnet component 520 from the cloud computing system 540, the user device user 542, or another external computing system or server in communication with the data processing system 502. The data processing system 502 can store and/or configure the BACnet component 520 based on configuration settings received from the cloud computing system 540, the user device user 542, another external computing system or server in communication with the data processing system 502, and/or input via an input device of the data processing system 502.

Implementing the BACnet component 520 can include executing processor-executable instructions of the BACnet component 520. In some implementations, the BACnet component 520 may execute as a background process (e.g., a daemon, a server, etc.) at the data processing system 502. The BACnet component 520 can listen for requests via one or more API endpoints and/or one or more BACnet messages from one or more of the BACnet systems 550. The BACnet component 520 can utilize the communications interface 504 and/or the BACnet interface 505 to communicate with one or more computing devices or systems external to the data processing system 502. In some implementations, the BACnet component 520 can communicate (e.g., via one or more inter-process communication (IPC) techniques) with the communication manager 522 to provide or receive information via the communications interface 504.

The BACnet component 520 can provide one or more APIs, or endpoints of APIs, that can receive commands for accessing various properties of, or to control, one or more of the BACnet systems 550 in communication with the data processing system 502. The APIs may be implemented as socket-based APIs. The socket-based APIs facilitate communication between processes, applications, and/or computing devices in a platform and language-agnostic manner. In some implementations, the BACnet component 520 can act as a server, and listen for commands or BACnet data via the socket-based APIs.

To provide the APIs, the BACnet component 520 can bind one or more sockets to an address and a port, which can identify a network location at which the BACnet component 520 can listen for incoming connections and/or API requests, messages, or data. To communicate with the BACnet component 520, a client (e.g., other software or components of the data processing system 502, the user device 542, the cloud computing system 540, other computing devices, etc.) can open a corresponding socket and initiate a connection request to the address and port bound by the BACnet component, e.g., by accessing a corresponding URI or URL identifying data processing system 502 (which may be initiated and/or managed by the communications manager 520). Once the communication session has been initiated, the client and the BACnet component 520 can communicate with one another by transferring data. Data transfer may be performed using one or more APIs, which may include any suitable, cross-platform API endpoint (e.g., REST endpoints, etc.).

In some implementations, the BACnet component 520 and any clients that communicate therewith to access the BACnet systems 550 can utilize ZeroMQ (ZMQ) messaging to provide and access the APIs of the BACnet component 520. ZMQ messaging can be implemented over a variety of socket types, including ZMQ_REQ, ZMQ_REP (e.g., request and reply), ZMQ_PUB, ZMQ_SUB (e.g. publish and subscribe), ZMQ_PUSH, ZMQ_PULL (e.g., push, pull via pipelines), and ZMQ_PAIR (e.g., peer-to-peer communications), among others. In some implementations, any clients that communicate with the BACnet component can access the APIs using software configured via templates, which may include pre-generated portion API requests, connection establishment routines, or other functionalities that are specific to a desired programming language or platform type that are to be implemented to communicate with the BACnet component 520. In some implementations, the BACnet component 520 can be implemented using a memory-safe programming language, such as Rust.

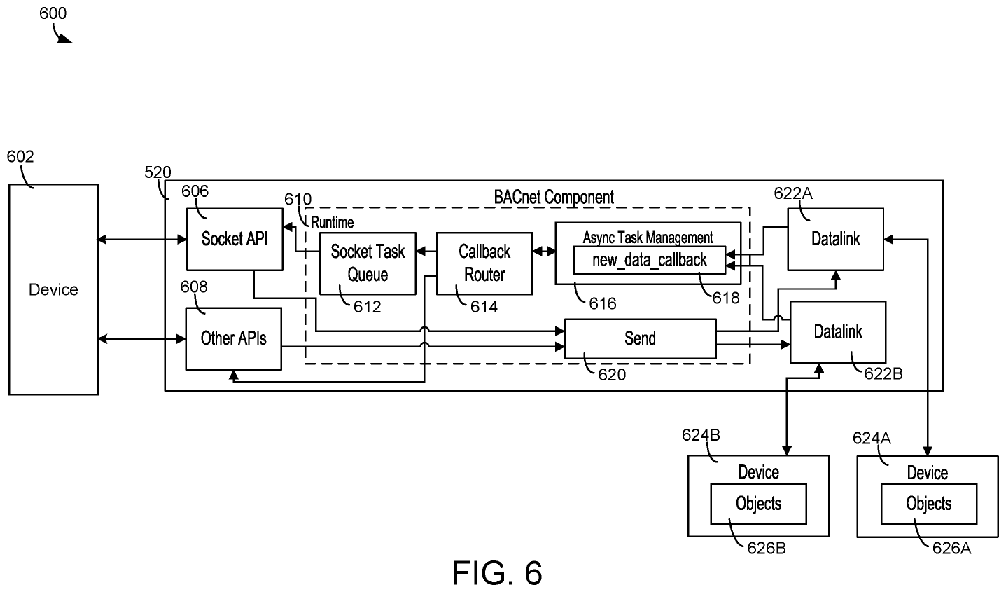

The BACnet component 520 can receive one or more command messages from one or more clients (e.g., a user device 542, cloud computing system 540, other components of the data processing system 502, other external computing systems, etc.) via one or more of the APIs provided by the BACnet component 520. The command can include any type of command to communicate via a BACnet protocol, for example, with one or more of the BACnet systems 550 in communication with the data processing system 502. The BACnet protocol can be used to facilitate communication and interaction between different devices and systems within a building automation network. The BACnet protocol can be used to identify, query, create, modify, or otherwise access one or more BACnet objects maintained by the BACnet systems 550. Further details of interactions between BACnet objects and the BACnet component 520 are described in connection with FIG. 6.

In some implementations, the data processing system 102 can receive API commands via a protocol different from the BACnet protocol, such as the ZMQ protocol, IP protocol, TCP/UDP protocols, HTTP/HTTPS protocols, or any other type of communication protocol different from BACnet protocols. API commands that may be received by the BACnet component 520 can include, but are not limited to, commands to retrieve at least one value from one or more BACnet objects maintained at a BACnet system 550, commands to control one or more BACnet systems (e.g., by writing to one or more BACnet objects, etc.), commands to read, write, subscribe (e.g., to changes), create, delete, reset, modify, or otherwise manage BACnet objects of a BACnet system, or commands to identify one or more BACnet systems 550 or BACnet objects of BACnet systems 550 in communication with the data processing system 502. The BACnet component 520 can provide one or more API endpoints, or otherwise communicate via one or more sockets, to receive any of the API commands described herein.

Upon receiving a command, the BACnet component 520 can convert the received BACnet communication to a corresponding BACnet instruction to communicate via the BACnet interface 505 with one or more BACnet systems 550, to carry out the received API command. For example, upon receiving a command to read a value of a BACnet object of a BACnet system 550, the BACnet component 550 can identify the corresponding BACnet object and BACnet system 550, and can generate a BACnet read property request to read a specified property from the BACnet object.

Similar techniques may be performed to convert a command to write to/control a BACnet system 550. For example, upon receiving a command to write a value to a BACnet object of a BACnet system 550, the BACnet component 550 can identify the corresponding BACnet object and BACnet system 550 and can generate a BACnet write property request to write a value to a specified property (e.g., an internally maintained value) of the BACnet object. Writing to the property may cause the BACnet system 550 to carry out one or more operations. For example, upon writing a value to a setpoint object of a temperature control system, the temperature control system can determine that the setpoint is different from the current temperature, and can automatically activate various HVAC equipment to regulate the temperature according to the setpoint.

In some implementations, the command may include a command to subscribe to changes of values maintained at one or more BACnet systems 550. Subscribing to a value of a BACnet system 550 can cause the BACnet system 550 to transmit any changes in said value to the BACnet component 520 (e.g., via the BACnet interface 505). The command can specify a time period that the client is to subscribe to the BACnet value (e.g., object property). The time period may be seconds, minutes, hours, days, weeks, months, years, etc. In some implementations, the command to subscribe to changes may specify an indefinite time period (e.g., subscribe until a second command canceling the subscription is received.

In some implementations, the command may include a command to identify one or more BACnet devices in communication with the data processing system 502. In response to the command, the BACnet component 520 can convert the command to a corresponding “who is” command that is transmitted via the BACnet interface 505. The who is command can cause each BACnet system 550 in communication with the data processing system 502 to transmit a response message that includes an identifier of the corresponding BACnet system 550. The message may further include identifiers or properties of one or more BACnet objects maintained by the BACnet systems 550, in some implementations.

Once the command has been converted to a corresponding BACnet instruction, the BACnet component 520 can transmit the BACnet instruction via the BACnet interface 505 to corresponding BACnet systems 550 using a BACnet protocol. Once the BACnet instruction is received, the BACnet systems can perform operations indicated in the instruction. For example, a specified BACnet system 550 can provide a property value of a BACnet object, write a value to or otherwise modify a BACnet object, publish values according to a requested subscription to a property of a BACnet object, and/or transmit a message identifying the BACnet system 550 or objects thereof, among any other BACnet operations. Response messages transmitted by the BACnet system(s) 550 can be received by the data processing system 502 via the BACnet interface 505 (or in some implementations, via the communications interface 504). The BACnet component 520 can then parse the response messages and provide corresponding data to a client of the BACnet component 520.

For example, upon receiving a response to a request for a property value of a BACnet object, the BACnet component 520 can extract the property value from the response message, and provide the property value to the client that transmitted the request via the APIs described herein. Similar messages may be transmitted to acknowledge write requests or other commands described herein. In some implementations, this may include converting the data into a transmission format compatible with the requesting client. For example, if a command is received from the cloud computing system 540, the BACnet component 520 can convert data of a received response message into a network format that is compatible with the network 530 (e.g., an IP packet, a TCP/UDP data packet, etc.). In some implementations, the BACnet component 520 can provide the data to the communications manager 522, which converts the data into the format compatible with the cloud computing system. Similar approaches may be utilized for any type of client, thereby enabling a hardware and software agnostic approach to managing response messages from BACnet systems 550 that operate using a BACnet protocol. An example dataflow diagram showing example operations of the BACnet component are shown in FIG. 6.

Referring to FIG. 6, illustrated is a block diagram 600 illustrating an example data flow diagram of an example BACnet integration component, according to some embodiments. The diagram 600 shows an example BACnet component 520 in communication with a device 602. The device 602 can be any type of device that communicates with the BACnet component 520, and in some implementations, may be the same device that executes the BACnet component 520. In other words, the BACnet component 520 may be a component of the device 602 in some embodiments and can be used by the device 602 to communicate via the BACnet protocol. In other embodiments, the BACnet component 520 may be separate from the device 602 and/or can be provided in the form of an add-on component (e.g., an expansion card, insertable module, plug-in device, etc.) which can be connected to the device 602 to add BACnet communications functionality to the device 602. In the diagram 600, arrows can designate flow of data to various components within the system.

The device 602 can provide requests and receive responses via one or more APIs, including, for example, a socket-based API 606 and/or other APIs 608. The socket-based APIs 606 may include, ZMQ APIs, while the other APIs 608 may include any other type of API endpoint that may not necessarily operate using sockets. Requests provided to the APIs (e.g., the socket APIs 606 and/or the other APIs 608) are provided to the runtime 610 of the BACnet component 520, which executes to carry out the runtime operations of the BACnet component 520. As shown, the commands received from the APIs are provided to the send component 620, which can convert the commands into corresponding BACnet instructions, as described herein. In some implementations, the send component 620 can include a queue data structure for load balancing BACnet instructions transmitted to the BACnet devices 624A and 624B.

As shown, the send component 620 can transmit and/or route the BACnet instructions to corresponding datalinks 622A and/or 622B, which may be or include any of the structure or functionality of the BACnet interface 505 described in connection with FIG. 5. Each data link 622A and 622B can communicatively link the BACnet component 520 to the one or more BACnet devices. In this example, a first datalink 622A is communicatively coupled to the first BACnet device 624A and a second datalink 622B is communicatively coupled to the first BACnet device 624B. Each BACnet device 624A and 624B (sometimes referred to as “BACnet device(s) 624”) can include, maintain, or otherwise store one or more corresponding BACnet objects 626A and 626B, respectively (sometimes generally referred to as BACnet object(s) 626).

The BACnet objects 626 can represent various aspects and components of a building system of a building, which may include any property or service implemented by a building device 62. A BACnet object 626 can be associated with specific properties and/or services that enable BACnet devices 624 to communicate and exchange information, among other functionality, including controlling environmental or operational parameters of a building or system. In some implementations, the BACnet objects 626 can include objects that are implemented as part of the BACnet standard. In some implementations, the BACnet objects 626 can include additional, custom objects that may be accessed according to the functionality described herein. For example, in some implementations, software development kit (SDK) templates may be utilized to define one or more custom objects that can be interfaced with via the BACnet component 520. For example, templates can be used to define or otherwise map various commands, protocols, or APIs of the BACnet component 520 to the custom BACnet objects. Custom BACnet objects may be implemented to extend the standard set of objects defined by the BACnet protocol to accommodate specific requirements or functionalities that are not covered by the standard objects, including various specialized equipment integrations, integrations with legacy systems, or integrations with non-BACnet enabled equipment.

Each of the BACnet devices 624 can receive BACnet instructions from via the send component 620, as described herein. In some implementations, the send component 620 may implement one or more load-balancing queues to coordinate transmission of BACnet instructions to corresponding BACnet devices. Any suitable balancing technique may be implemented via the send component 620, including but not limited to round-robin transmission, priority queue-based transmission, or other rule-based transmission policies for various BACnet devices. Each of the BACnet datalinks 622A and 622B (sometimes generally referred to as the datalink(s) 622) can receive one or more signals (e.g., response messages, status messages, etc.) from one or more BACnet devices 624 in communication with the corresponding datalink 622. For example, the datalinks 622 may receive response messages asynchronously.

Asynchronous messages received via the datalinks 622 can be provided to the asynchronous task management component 616. The asynchronous task management component 616 can be any type of software and/or hardware component that can receive and process messages asynchronously. For example, the asynchronous task management component 616 may implement a new data callback function 618 asynchronously, which performs initial pre-processing on BACnet frames received via the datalink(s) 622. The new data callback function 618 can be any type of function that is invoked by the asynchronous task management component 616 that performs initial processing on received BACnet data frames. Any type of callback function can be implemented to perform any suitable data processing, including processing to ensure that the received message complies with the BACnet protocol.

Output of the asynchronous task management component 616 can be provided to the callback router 614, which can include any type of software, hardware, or combinations thereof that facilitates the routing or handling of callback functions based on specific events or conditions. The callback router 614 can enable customization of the behavior of the BACnet component 520 in response to various events, including particular data received as part of BACnet data frames. For example, the callback router 614 may determine which callback function of the BACnet component, if any, to invoke based on the data included in the received information provided by the BACnet device(s) 624. Callback functions may be implemented as part of the BACnet component 520 or may correspond to other components of a system that executes the BACnet component 520. In some implementations, callback functions implemented via the callback router 612 can be or may include device- or platform-specific callback functions. The callback router 614 can, in some implementations, execute any callback function of the BACnet component 520 based on information received from the asynchronous task management component 616.

As shown, the callback router 614 can provide resulting data (e.g., the received data frames and/or information produced via any invoked callback functions, etc.) to the device 602 via the socket APIs 606 and/or the other APIs 608. In some implementations, the callback router 614 can provide the information via a socket task queue 612, which may be a load-balancing, distributed queue for providing response messages via the socket API 606. The socket task queue 612 can be implemented using any suitable data structure, including a priority queue data structure, a distributed queue data structure, or other type of load-balancing data structure. The socket task queue 612 can provide indications to transmit any received response messages and/or processed data produced by callback functions to a corresponding endpoint of the socket API 606. In some implementations, the socket task queue 612 can automatically push data to the device 602 via a corresponding socket API 606.

Although shown as communicating with two BACnet devices 624 via two corresponding BACnet data links 622, it should be understood that the BACnet component 520 can be used to communicate using any number of data links 622, which may be in communication with any number of BACnet devices 624. For example, one physical data link 622 may be utilized to communicate with one or more BACnet devices 624. Likewise, the BACnet component 520 can be used to communicate via one or multiple BACnet data links 622. Transmitting the response messages may include converting BACnet data frame response messages to a format compatible with the socket APIs 606 and/or the other APIs 608. In some implementations, such data conversion may be performed via the callback router 614, for example, by invoking one or more corresponding callback functions. Using the forementioned techniques, the BACnet component 520 implements a device and platform agnostic communication stack between the device 602 and the BACnet devices 622. The BACnet component 520 may be implemented on any type of device described herein, including on gateway devices, server devices, client devices, or any type of BACnet-compatible device.

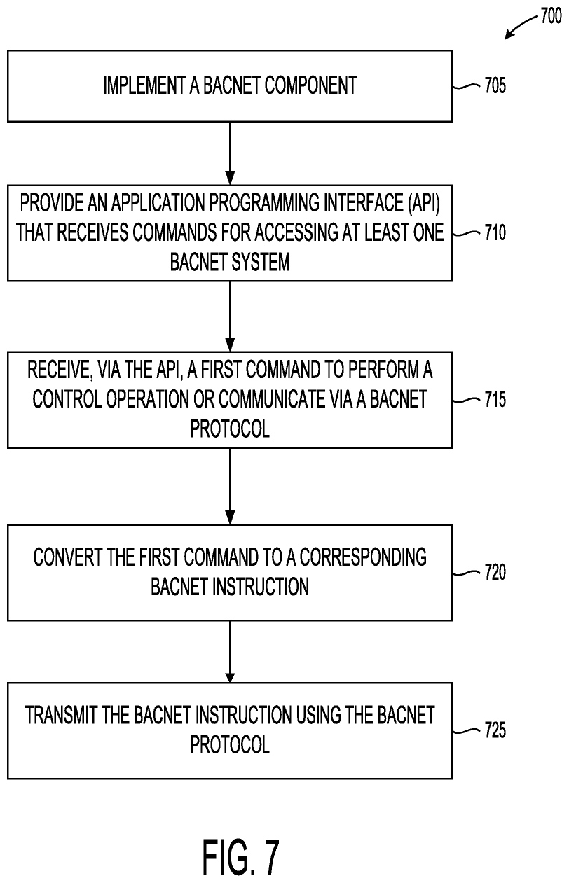

Referring to FIG. 7, illustrated is a flowchart of an example process 700 for implementing an example BACnet integration component, according to some embodiments. The process 700 may be performed, for example, by the data processing system 502, the BACnet systems 550, the user device 542, the cloud computing system 540, or any other computing device described herein. Although the steps of the process 700 are shown in a particular order, it should be understood that additional steps may be performed, some steps may be omitted, and steps may be performed in a different order, to achieve desired results. Each of steps 705-725 may be an act performed to execute a portion of the process 700. To improve computational efficiency, steps may be performed in parallel rather than sequentially.

At STEP 705, a data processing system (e.g., the data processing system 502) can implement a BACnet component (e.g., the BACnet component 520). Implementing the BACnet component can include executing the BACnet component as a background process, or otherwise invoking the BACnet component to coordinate communications via a BACnet interface. In some implementations, the BACnet component can be invoked as part of a startup routine or in response to a message transmitted to the data processing system. In some implementations, the BACnet component can be invoked in response to input at the data processing system.

At STEP 710, the BACnet component of the data processing system can provide an API (e.g., the socket API 606, the other API 608, etc.) that can receive commands for accessing at least one BACnet system (e.g., one or more BACnet systems 550, one or more of the BACnet devices 624, etc.). The BACnet component may provide one or more socket-based APIs, such as ZMQ APIs. In some implementations, the BACnet component may provide one or more web-based APIs, such as HTTP/HTTPS APIs. The BACnet component may provide any number of APIs with any number of endpoints, which may be accessed to transmit and/or receive messages for controlling or otherwise accessing BACnet systems.

At STEP 715, the BACnet component executed by the data processing system can receive, via the API, one or more commands to communicate via a BACnet protocol. The commands may include any type of API command or message that includes indications of a BACnet device and/or BACnet operation to access or perform via a BACnet network. The commands may be received via a network protocol (e.g., ZMQ, HTTP/HTTPS) that is different from the BACnet protocol. Commands received via the APIs can include commands to retrieve at least one value from a BACnet system, commands to control one or more BACnet systems, commands to modify values of one or more BACnet systems, commands to subscribe to changes in values of one or more BACnet systems, or commands to identify one or more BACnet systems, among others.

At STEP 720, the BACnet component executed by the data processing system can convert received command(s) to corresponding BACnet instruction(s). For example, the BACnet component can generate corresponding BACnet instructions that perform the commands received via the APIs, which may be transmitted in a network or data structure format that is different from the BACnet protocol. In an example where the API command is a command to retrieve or subscribe to a value of a BACnet system, the BACnet instruction can be generated as a read value or a subscribe to change in value instruction. In an example where the API command is a command to modify a value of or control a BACnet system, the BACnet instruction can be generated as a write value instruction. In an example where the API command is a command to discover one or more BACnet systems, the BACnet instruction can be generated as a “who is” instruction. Various parameters may also be specified via the input command and used to convert/generate corresponding BACnet instructions, such as a subscription time interval, identification of a property and/or BACnet object, as well as identification of a BACnet system, among others.

At STEP 725, the BACnet component executed at the data processing system can transmit the BACnet instruction using the BACnet protocol. The BACnet component can transmit the BACnet instruction, for example, via a BACnet interface (e.g., the BACnet interface 505). In some implementations, the BACnet component can receive response messages via the BACnet interface (e.g., in response to transmitted commands). The response messages may be transmitted by the BACnet systems asynchronously with respect to the transmitted BACnet instructions. In some implementations, the BACnet component can implement one or more load balancing, distributed queues that store the BACnet instructions to be transmitted and/or BACnet response messages received from the BACnet systems. In some implementations, the BACnet response messages can be converted into a network format compatible with the device that transmitted an instruction corresponding to the response message. Information from the BACnet response message can be transmitted to a corresponding networked device via the APIs of the BACnet component, as described herein. For example, the BACnet component can transmit information from the response messages to a cloud computing system or user device, in some implementations.

In some embodiments, various data discussed herein may be stored in, retrieved from, or processed in the context of digital twins. In some such embodiments, the digital twins may be provided within an infrastructure such as those described in U.S. patent application Ser. No. 17/134,661 filed Dec. 28, 2020, Ser. No. 18/080,360 filed Dec. 13, 2022, and Ser. No. 17/537,046 filed Nov. 29, 2021, the entireties of each of which are incorporated herein by reference. For example, one or more operations of the computing platform may be performed to modify one or more digital twins to include standardized object names generated using machine learning models, as described herein.

In some embodiments, various data or components discussed herein may be processed at (e.g., processed using models executed at) or executed by a cloud or other off-premises computing system/device or group of systems/devices, an edge or other on-premises system/device or group of systems/devices, or a hybrid thereof in which some processing occurs off-premises and some occurs on-premises. In some example implementations, the data may be processed using systems and/or methods such as those described in U.S. patent application Ser. Nos. 17/710,458, 17/710,782, 17/710,743, 17/710,775, 17/710,535, and 17/710,542 (all filed Mar. 31, 2022), and U.S. Provisional Patent No. 63/411,540 filed Sep. 29, 2022, which are all incorporated herein by reference in their entireties. For example, one or more operations of the computing platform may be implemented by various gateway components or software, which may be retrieved from or provided by a cloud system. In some implementations, operations described herein as being performed by the computing platform may be performed by one or more edge devices.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

References to “or” may be construed as inclusive so that any terms described using “or” may indicate any of a single, more than one, and all of the described terms.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system, comprising:
one or more processors coupled to non-transitory memory, the one or more processors configured to:
implement a building automation control network (BACnet) component configured to:
provide a socket-based application programming interface (API) configured to receive commands for accessing at least one BACnet system;
receive, via the socket-based API, a first command to be communicated via a BACnet protocol;
convert the first command to a BACnet instruction; and
transmit the BACnet instruction using the BACnet protocol to the BACnet system.

2. The system of claim 1, wherein the first command is received according to a first network protocol different from the BACnet protocol.

3. The system of claim 1, wherein the first command comprises a command to retrieve at least one value from the BACnet system or a command to control the BACnet system.

4. The system of claim 3, wherein the first command comprises the command to control the BACnet system, and wherein transmitting the BACnet instruction to the BACnet system causes the BACnet system to modify an internal value maintained by the BACnet system.

5. The system of claim 3, wherein the first command comprises the command to retrieve the at least one value from the BACnet system, and wherein the BACnet component is further configured to:
convert the first command to the BACnet instruction to retrieve the at least one value from the specified BACnet system; and
retrieve, using the BACnet instruction, the at least one value from the specified BACnet system.

6. The system of claim 5, wherein the first command identifies a time period for retrieving values from the specified BACnet system, and wherein the BACnet component is further configured to retrieve the at least one value from the specified BACnet system prior to expiration of the time period.

7. The system of claim 1, wherein the BACnet component is further configured to:
receive, via the socket-based API, a second command to identify BACnet systems on a network;
convert the second command to a second BACnet instruction; and
identify, via the BACnet protocol and using the second BACnet instruction, one or more BACnet systems on the network.

8. The system of claim 1, wherein the first command is received from a computing system or a component, the BACnet component further configured to:
receive a response to the BACnet instruction;
generate data based on to the response according to a format compatible with the computing system or the component; and
transmit the data to the computing system or the component.

9. The system of claim 1, wherein the BACnet component is further configured to store the first command in a load-balancing queue data structure.

10. The system of claim 1, wherein the BACnet component is further configured to:
receive a response to the BACnet instruction from the BACnet system; and
store at least a portion of the response in a task queue data structure.

11. A method, comprising:
implementing, by one or more processors coupled to non-transitory memory, a building automation control network (BACnet) component;
providing, by the BACnet component, a socket-based application programming interface (API) configured to receive commands for accessing at least one BACnet system;
receiving, by the BACnet component via the socket-based API, a first command to be communicated via a BACnet protocol;
converting, by the BACnet component, the first command to a BACnet instruction; and
transmitting, by the BACnet component, the BACnet instruction using the BACnet protocol to the BACnet system.

12. The method of claim 11, wherein the first command is received according to a first network protocol different from the BACnet protocol.

13. The method of claim 11, wherein the first command comprises a command to retrieve at least one value from the BACnet system or a command to control the BACnet system.

14. The method of claim 13, wherein the first command comprises the command to control the BACnet system, and wherein transmitting the BACnet instruction to the BACnet system causes the BACnet system to modify an internal value maintained by the BACnet system.

15. The method of claim 13, wherein the first command comprises the command to retrieve the at least one value from the BACnet system, and wherein the method further comprises:
converting, by the BACnet component, the first command to the BACnet instruction to retrieve the at least one value from the BACnet system; and
retrieving, by the BACnet component using the BACnet instruction, the at least one value from the BACnet system.

16. The method of claim 15, wherein the first command identifies a time period for retrieving values from the specified BACnet system, and wherein the method further comprises the BACnet component retrieving the at least one value from the specified BACnet system prior to expiration of the time period.

17. The method of claim 11, further comprising:
receiving, by the BACnet component via the socket-based API, a second command to identify BACnet systems on a network;
converting, by the BACnet component, the second command to a second BACnet instruction; and
identifying, by the BACnet component via the BACnet protocol and using the second BACnet instruction, one or more BACnet systems on the network.

18. The method of claim 11, wherein the first command is received from a computing system or a component, the method further comprising:
receiving, by the BACnet component, a response to the BACnet instruction;
generating, by the BACnet component, data based on to the response according to a format compatible with the computing system or the component; and
transmitting, by the BACnet component, the data to the computing system or the component.

19. The method of claim 11, further comprising storing, by the BACnet component, the first command in a load-balancing queue data structure.

20. The method of claim 11, further comprising:
receiving, by the BACnet component, a response to the BACnet instruction from the BACnet system; and
storing, by the BACnet component, at least a portion of the response in a task queue data structure.
